(19) United States
(12) Patent Application Publication
(10) Pub. No.: US 2004/0084876 A1
(43) Pub. Date: May 6, 2004

(54) Docking guidance indicator

(76) Inventor: Jerry Lee Losee, Lava Hot Springs, ID (US)

Correspondence Address: Thompson E. Fehr, Goldenwest Corporate Center, Suite 300, 5025 Adams Avenue, Ogden, UT, 84403, US

(21) Appl. No.: 10/444,750

(22) Filed: May 23, 2003

Related U.S. Application Data
(63) Continuation-in-part of application No. 09/136,979, filed on Aug. 20, 1998, now Pat. No. 6,568,700.
(60) Provisional application No. 60/056,813, filed on Aug. 22, 1997.

(51) Int. Cl. B60D 1/00

(52) U.S. Cl. 280/477

(57) ABSTRACT

A docking structure having an electrically conductive cable with a proximal end attached to a retractable cable reel assembly to be secured to a proximal vehicle and a distal end to be attached to a connector on a distal stationary apparatus. The electrically conductive cable runs between a left contact and a right contact. If the proximal vehicle is turned too sharply to the left in attempting to align a connector on the proximal vehicle and a connector on the distal stationary apparatus, a left light connected—either with a wire or through a transmitter and receiver—to the left contact, is illuminated. A right light operates similarly. And both lights are illuminated simultaneously when the connectors are properly aligned.

### CROSS-REFERENCE TO RELATED APPLICATION

This is a continuation-in-part of copending U.S. application Ser. No. 09/136,979, filed on Aug. 20, 1998, which will issue as U.S. Pat. No. 6,568,700 on May 27, 2003 and which was a continuation-in-part of then copending U.S. provisional application serial No. 60/056,813, filed on Aug. 22, 1998.

### BACKGROUND OF THE INVENTION

1. Field of the Invention

This invention relates to a device for guiding a driver backing a motor vehicle in order to connect the vehicle to a trailer.

2. Description of the Related Art

U.S. Pat. No. 3,938,122 of Mangus discloses a car-to-trailer docking device which includes a cable associated with a sensor apparatus to be mounted on a car. The cable is attached to a trailer. However, the cable does not conduct electricity. The deviation of the angle of the cable from a line running parallel to the length of the car is sensed by a mechanical pivoting plate (76). As the plate deviates from being perpendicular to a line between the car and the trailer, the plate triggers electric switch which, in turn, activate guidance lights for the driver. The device of Mangus requires many mechanical parts, including a pivot, a plate, a spring, and a plurality of switches. All these parts must be weatherproofed to withstand an outside environment. The device of Mangus also uses a motorized rewind motor and a bumper brace mount kit.

U.S. Pat. No. 5,513,870 of Hickman discloses an electronic version of a trailer docking device. Once again, however, the cable does not carry electricity. The sensing apparatus of the Hickman invention comprises a pivoting box which rotates in respons to activation by the cable of a shutter element. Pivoting of the box from being perpendicular to a line between the car and the trailer activates a driver's display unit.

### BRIEF SUMMARY OF THE INVENTION

The present invention runs an electric current through a cable that is attached to the hitch of a trailer. The cable passes between left and right metal contacts, alternatively designated herein “contact switches” in a principal box mounted on the rear of a motor vehicle to which the trailer is to be connected.

The metal contacts are connected to a left light and a right light in a display box to be mounted on the vehicle anywhere within the driver's field of view. Such connection may either be with electrical wiring or a transmitter in the principal box and a receiver in the display box.

When the cable touches the left metal contact, the left light is illuminated, indicating that the driver of the motor vehicle should be turning less to the left. Similarly, when the cable touches the right metal contact, the right light is illuminated, indicating that the driver of the motor vehicle should be turning less to the right.

Movably attached to the electrically conductive cable is an electrically conductive nut sized so that it can contact both the left metal contact and the right metal contact simultaneously. When such simultaneous contact occurs, both the left light and the right light are illuminated, indicating that the driver should cease backing the vehicle.

### BRIEF DESCRIPTION OF THE SEVERAL VIEWS OF THE DRAWING

FIG. 1 provides a view of the assembled Docking Guidance Indicator utilizing wiring to connect the left metal contact to the left light and the right metal contact to the right light.

FIG. 2 is an exploded view for the embodiment of FIG. 1.

FIG. 3 portrays the assembled Docking Guidance Indicator using a transmitter and a receiver to connect the left metal contact to the left light and the right metal contact to the right light.

FIG. 4 shows and exploded view for the embodiment of FIG. 3.

### DETAILED DESCRIPTION OF THE INVENTION

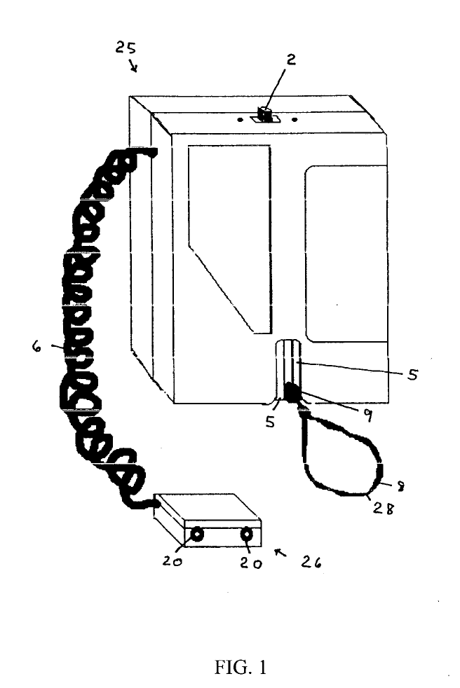

As indicated above, FIG. 1 provides a view of the assembled Docking Guidance Indicator utilizing wiring to connect the left metal contact 5 to the left light 20 and the right metal contact 5 to the right light 20.

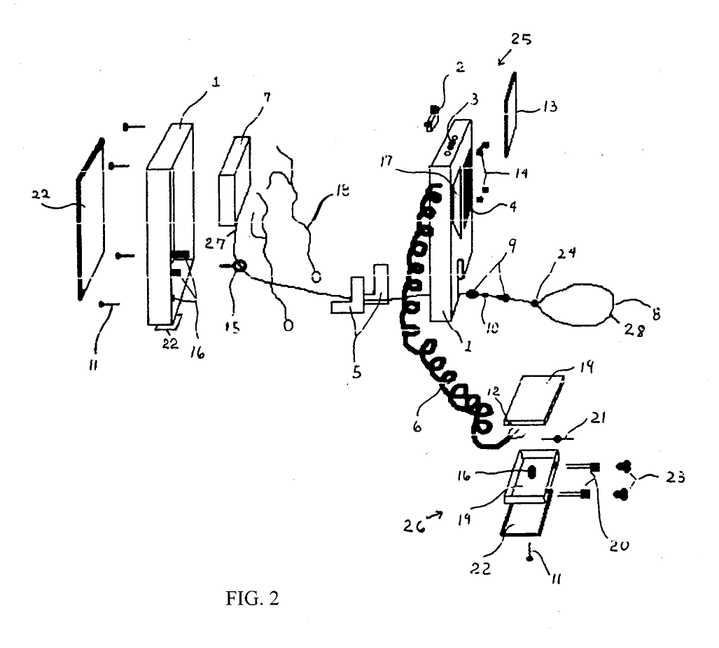

FIG. 2 shows the various components of this embodiment. A principal box 25 contains most of the sensing equipment, and a display box 26 contains the indicating equipment.

The principal box 25 is preferably comprised of two halves 1.

An electrically conductive cable 8, preferably made from steel, runs between left and right metal contacts 5. An adapter 4 for connection to an electric power source, such as a plug from a wall outlet or a battery, may either be a receptacle for the plug or a battery compartment containing contacts for the battery terminals; this adapter 4 receives electrical power from the electric power source.

When the cable 8 touches the left metal contact 5, electricity is conducted from the electric power source, through the adapter 4, optionally (but preferably) through an on-off switch 2, through electrical wire 18, through an alignment screw 15 which the cable 8 slidably touches, through the cable 8, through the left metal contact 5, through a first wire in the wire cord 6, to the left light of two lights 20 (which lights 20 are preferably light-emitting diodes), and through a second wire in the wire cord 6 back to the adapter 4 and to the electric power source.

When the cable 8 touches the right metal contact 5, electricity is conducted from the electric power source, through the adapter 4, optionally (but preferably) through an on-off switch 2, through electrical wire 18, through an alignment screw 15 which the cable 8 slidably touches, through the cable 8, through the right metal contact 5, through a third wire in the wire cord 6, to the right light of the two lights 20 (which lights 20 are preferably light-emitting diodes and which light-emitting diodes are preferably mounted in led holders 23), and through a second wire in the wire cord 6 back to the adapter 4 and to the electric power source.

The on-off switch 2 preferably fits into switch mount holes 3. When a battery is to be used as the electric power source, the adapter 4 contains battery clips 14.

The alignment screw 15 is attached to the principal box 25 and maintains the cable 8 centered substantially between the left and right metal contacts 5.

A proximal end 27 of the cable 8 is attached to a retractable cable reel assembly 7, into which the cable can be retracted; and a distal end 28 of the cable 8 is adapted for attachment to a distal stationary apparatus such as the hitching ball of a trailer. Such adaptation preferably comprises a loop at the distal end 28 of the cable 8 maintained with a crimped cable connector 24.

Also, as indicated above, movably attached to the cable 8 is an electrically conductive nut 9 sized so that such nut 9 can contact both the left metal contact 5 and the right metal contact 5 simultaneously, thereby activating both the left light 20 and the right light 20.

Preferably, the electrically conductive nut 9 comprises a captive screw and acorn nut preferably with an optional rubber bushing mounted between the captive screw and the acorn nut. When the captive screw and acorn nut are tightened together, the nut 9 remains in position.

A resistor 21 in the circuitry associated with the lights 20 regulates the current that reaches such lights 20.

As is the principal box 25, the display box 26 is preferably comprised of two halves 19.

Preferably, both the principal box 25 and the display box 26 contain screw posts 16 which, together with screws 11, hold the halves 1 of the principal box 25 together and the halves 19 of the display box 26 together.

Also preferably, magnets 22, preferably, flexible magnets 22, are attached to the bottom of the principal box 25 and, preferably, to the bottom of the display box 26 for mounting such boxes 25, 26 on a metallic portion of a vehicle.

Preferably, a lid 13 slides into grooves in order to cover the adapter 4; wire mount holes 12 hold the wire cord 6 in place; and a label can be attached to the indented area 17.

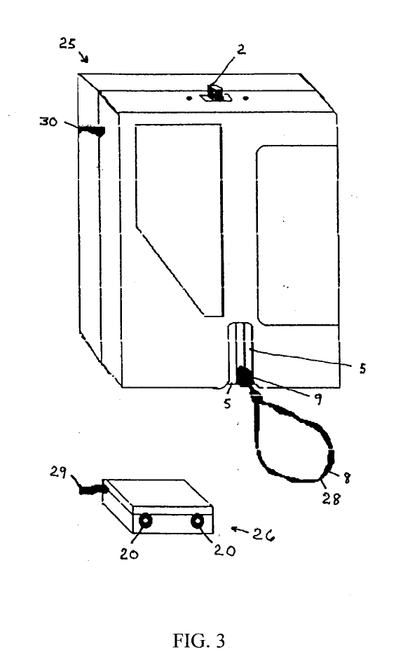

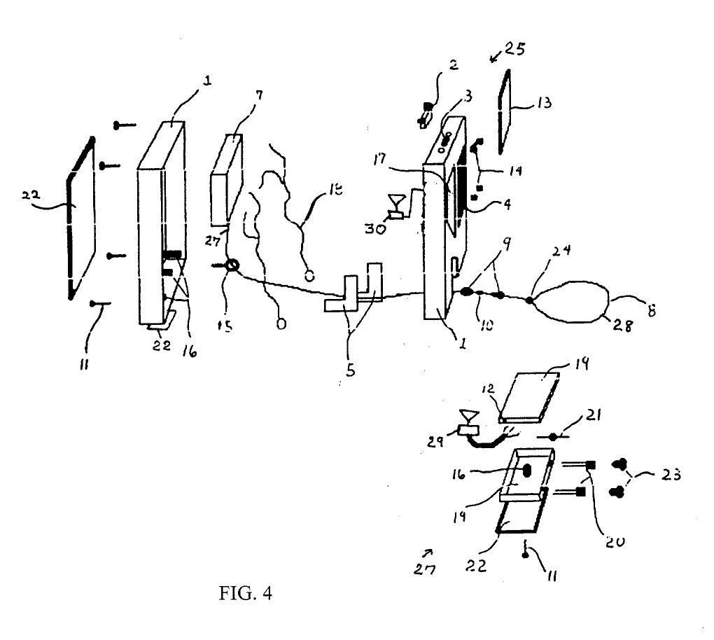

Optionally, in lieu of connecting the left metal contact 5 to the left light 20 with a first wire in the wire cord 6 and the right metal contact 5 to the right light 20 with a third wire in the wire cord 6, the left and right metal contacts 5 are, as shown in FIG. 3 and FIG. 4, connected to a transmitter 29 which communicates with a receiver 30 connected to the two lights 20. The functioning of the Docking Guidance Indicator is otherwise the same as when a wire cord 6 is utilized.

The Docking Guidance Indicator assists a driver in backing a proximal vehicle, especially a motor vehicle, to be connected to a distal stationary apparatus, usually a trailer, without assistance from another human being and without requiring the driver repeated to exit and re-enter the vehicle to assure that the mating parts of the connector will be properly aligned.

In order to operate the Docking Guidance Indicator, the principal box 25 is placed above a receiver or directly behind the ball of the connector, preferably being held in place by the magnet 22 on the bottom of the principal box 25. Next, the display box 26 is placed anywhere on the vehicle within the driver's field of view and is, preferably, retained in place by the magnet 22 on the bottom of the display box 26.

The distal end 28 of the cable 8 is placed over the point for attachment of the connector on the proximal vehicle (the connecting portion of the receiver or the ball of a connector), and the electrically conductive nut 9 is moved along the cable 8 until the nut 9 touches the left and right metal contacts 5. The nut 9 is then locked at that position on the cable 8. Subsequently, the distal end 28 of the cable 8 is pulled and attached to the connector on the distal stationary apparatus.

When the driver is backing and one of the lights 20 illuminates, it indicates that the driver should turn less in the direction of the illuminated light 20. When the left light 20 and the right light 20 illuminate simultaneously, the driver should stop because the proximal vehicle has reached the position for connecting to the distal stationary apparatus.

I claim:

1. A docking structure for a proximal vehicle and distal stationary apparatus, to assist the operator of the vehicle in backing up, comprising:
an adapter;
an electrically conductive cable;
a retractable cable reel assembly having the proximal end of said electrically conductive cable connected to said cable reel assembly;
an electrically conductive nut movably attached to said cable, said nut being sized so that said nut can contact both said left and said right metal switches simultaneously;
left and right metal contact switches mounted respectively on a left and right side of said electrically conductive cable and connected to said adapter;
and a left and right light connected respectively to said left and right metal contact switches, wherein when said electrically conductive cable touches said left metal contact switch and said adapter has been connected to an electric power source, said contact powers said left light, and when said electrically conductive cable touches said right metal contact switch and said adapter has been connected to an electric power source, said contact powers the right light, thereby enabling the operator to adjust the vehicle when said retractable cable reel assembly is secured to said vehicle and the distal end of said electrically conductive cable is attached to said stationary apparatus, said movable nut, when said adapter has been connected to an electric power source, powering both lights simultaneously when said movable nut is adjusted to a preset position on the electrically conductive cable and said movable nut further comprising an acorn nut and a captive screw.

2. The docking structure for a proximal vehicle and distal stationary apparatus, to assist the operator of the vehicle in backing up as recited in claim 1, further comprising:
a magnet securing said retractable cable reel assembly to said vehicle.

3. The docking structure for a proximal vehicle and distal stationary apparatus, to assist the operator of the vehicle in backing up as recited in claim 2, further comprising:
a magnet for securing said left light and said right light to said vehicle.

4. A docking structure for a proximal vehicle and distal stationary apparatus, to assist the operator of the vehicle in backing up, comprising:
an adapter;
an electrically conductive cable;
a retractable cable reel assembly having the proximal end of said electrically conductive cable connected to said cable reel assembly;
an electrically conductive nut movably attached to said cable, said nut being sized so that said nut can contact both said left and said right metal switches simultaneously;
left and right metal contact switches mounted respectively on a left and right side of said electrically conductive cable and connected to said adapter;
a transmitter;
a receiver; and
a left and right light connected, through said transmitter and said receiver, respectively to said left and right metal contact switches, wherein when said electrically conductive cable touches said left metal contact switch and said adapter has been connected to an electric power source, said contact powers said left light, and when said electrically conductive cable touches said right metal contact switch and said adapter has been connected to an electric power source, said contact powers the right light, thereby enabling the operator to adjust the vehicle when said retractable cable reel assembly is secured to said vehicle and the distal end of said electrically conductive cable is attached to said stationary apparatus, said movable nut, when said adapter has been connected to an electric power source, powering both lights simultaneously when said movable nut is adjusted to a preset position on the electrically conductive cable and said movable nut further comprising an acorn nut and a captive screw.

5. The docking structure for a proximal vehicle and distal stationary apparatus, to assist the operator of the vehicle in backing up as recited in claim 4, further comprising:
a magnet securing said retractable cable reel assembly to said vehicle.

6. The docking structure for a proximal vehicle and distal stationary apparatus, to assist the operator of the vehicle in backing up as recited in claim 5, further comprising:
a magnet for securing said left light and said right light to said vehicle.
